(19) United States
(12) Patent Application Publication
(10) Pub. No.: US 2008/0297912 A1
(43) Pub. Date: Dec. 4, 2008

(54) VARIO-ASTIGMATIC BEAM EXPANDER

(75) Inventor: Leo Baldwin, Portland, OR (US)

Correspondence Address: ELECTRO SCIENTIFIC INDUSTRIES/STOEL RIVES, LLP, 900 SW FIFTH AVE., SUITE 2600, PORTLAND, OR, 97204-1268, US

(73) Assignee: Electro Scientific Industries, Inc., an Oregon corporation, Portland, OR (US)

(21) Appl. No.: 11/757,267

(22) Filed: Jun. 1, 2007

(51) Int. Cl. G02B 13/08

(52) U.S. Cl. 359/668

(57) ABSTRACT

A vario-astigmatic beam expander is capable of collimating an astigmatic light beam, or inducing astigmatism in a well-collimated beam, by passing the light beam through a combination of spherical and cylindrical lenses, whereby both the degree of astigmatism and the axis of astigmatism induced are continuously adjustable. The beam expander has applications in industrial laser processing systems.

### COPYRIGHT NOTICE

2007 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure concerns using optical elements to modify properties of a light beam.

### BACKGROUND INFORMATION

In an industrial laser processing system, it may be desirable for a laser beam to have a symmetrically round cross section and for the laser beam to be collimated, that is, with light rays propagating along and parallel to an optic axis. However, in certain applications, it may be preferable to de-focus the laser beam by forcing some of the light rays to converge or diverge away from the optic axis. Such a beam with light rays that converge or diverge asymmetrically is defined as astigmatic. As an astigmatic laser beam propagates along a path through space, the laser beam spot on a target becomes increasingly asymmetric, changing shape from circular to elliptical, or “anamorphic.” Anamorphic laser beam spots, like ellipses, are characterized by their eccentricity, a measure of elongation of the ellipse. The ability to de-focus a laser beam may be advantageous when creating an autofocus control feature or protecting a workpiece from excess energy absorption (laser burning). Conversely, a laser may produce an astigmatic beam in applications requiring a well-collimated beam with no astigmatism. In such a case it is preferable to force all the light rays in the system to align with the optic axis.

Correcting astigmatism in a poorly collimated beam, or inducing astigmatism in a well-collimated beam, may be achieved by passing the laser beam through a cylindrical lens, either alone or in combination with a spherical lens. A spherical lens has one or more curved surfaces that resemble the surface of a sphere; a cylindrical lens has one or more curved surfaces that resemble the surface of a cylinder. Whereas a spherical lens, such as a typical piano-convex or plano-concave lens, causes parallel rays of light to converge or diverge in all directions, a cylindrical lens causes convergence or divergence in a single plane. Thus, while spherical lenses are used to magnify or reduce image size proportionally, cylindrical lenses are used to stretch an image along a particular axis. Although a single cylindrical lens can correct or introduce astigmatism, it cannot affect the degree of asymmetry in a beam. A system of cylindrical lenses, arranged in a telescope configuration, can affect the symmetry of the beam independent of the astigmatism.

### SUMMARY OF THE DISCLOSURE

A preferred embodiment of a vario-astigmatic beam expander is capable of either introducing a continuously variable degree of astigmatism into a well-collimated laser beam or correcting a degree of astigmatism in a poorly collimated laser beam. The vario-astigmatic beam expander is based on a traditional telescope, which is comprised of two spherical lenses. Substituting a pair of cylindrical lenses for the second spherical lens allows astigmatism to be adjusted by rotating the principal axes of the two cylindrical lenses relative to each other. The angle between the principal axes is defined as the rotation angle. When the principal axes of the two cylindrical lenses are orthogonal, i.e. the rotation angle is 90 degrees, there is no astigmatism in the emerging beam, and the spot shape is circular with zero eccentricity. Moving the rotation angle away from an orthogonal orientation causes the beam to become increasingly astigmatic, and the spot shape to become more elongated. Rotating the pair of cylindrical lenses together causes rotation of the axis of astigmatism

Additional aspects and advantages will be apparent from the following detailed description of preferred embodiments, which proceeds with reference to the accompanying drawings.

### BRIEF DESCRIPTION OF THE DRAWINGS

FIGS. 1A, 1B, and 1C are diagrams of three prior art anamorphic telescopes made from various configurations of prisms.

FIGS. 2A and 2B are diagrams of, respectively, prior art Keplerian and Galilean beam expanders, which represent two examples of traditional telescopes made from spherical lenses.

FIG. 3A is a schematic of an embodiment of a vario-astigmatic beam expander, which includes a single spherical element and a pair of cylindrical elements of the same magnifying power.

FIG. 3B is an isometric view of an optical module embodying the vario-astigmatic beam expander of FIG. 3A.

FIG. 4A is a ray diagram of a prior art fixed beam expander (telescope), which has no effect on astigmatism.

FIG. 4B is a ray diagram of a vario-astigmatic fixed-ratio beam expander in a zero-astigmatism configuration, which produces an optical output equivalent to that produced by the configuration in FIG. 4A.

FIG. 4C is a ray diagram of a vario-astigmatic fixed-ratio beam expander in an astigmatic configuration.

FIGS. 5A and 5B are drawings showing differences between beam spots formed by anamorphic and astigmatic beams, respectively.

FIG. 6A represents a schematic combination of FIG. 3A and FIG. 5B depicting a vario-astigmatic beam expander deployed in a system implemented with scan mirrors and a scan lens.

FIG. 6B is a contour plot of light intensities for an image produced by the system of FIG. 6A as predicted by a computer model.

FIG. 6C is a pair of irradiance plots obtained by sectioning the contour plot shown in FIG. 6B along its x- and y-axes.

FIG. 7 is a ray diagram of an alternative embodiment of a vario-astigmatic beam expander, in which crossed cylindrical lenses are positioned at the system input.

FIGS. 8A, 8B, and 8C are ray diagrams of three configurations of a conventional zoom beam expander with no provision for astigmatism. The expansion ratio in each configuration is adjusted by varying the distances between successive pairs of the three lens elements.

FIG. 9 is a ray diagram of a zoom beam expander using a pair of cylindrical lenses adjusted for zero astigmatism.

FIG. 10 is a ray diagram of a zoom beam expander using a pair of cylindrical lenses adjusted for a selected amount of variable astigmatism.

### DETAILED DESCRIPTION OF PREFERRED EMBODIMENTS

A “beam expander” expands a beam of parallel light rays about an optic axis (represented in the accompanying drawing as a line formed of alternating dots and dashes), to form a larger diameter beam. Beam expanders can be constructed with lenses or prisms. Both prisms and lenses magnify by decelerating light rays, causing them to bend. Prisms have straight surfaces; lenses have curved surfaces. The difference in index of refraction between glass and air determines how much deceleration occurs, and the angle of the glass surface presented to the incident light beam controls which rays within the light beam are bent first.

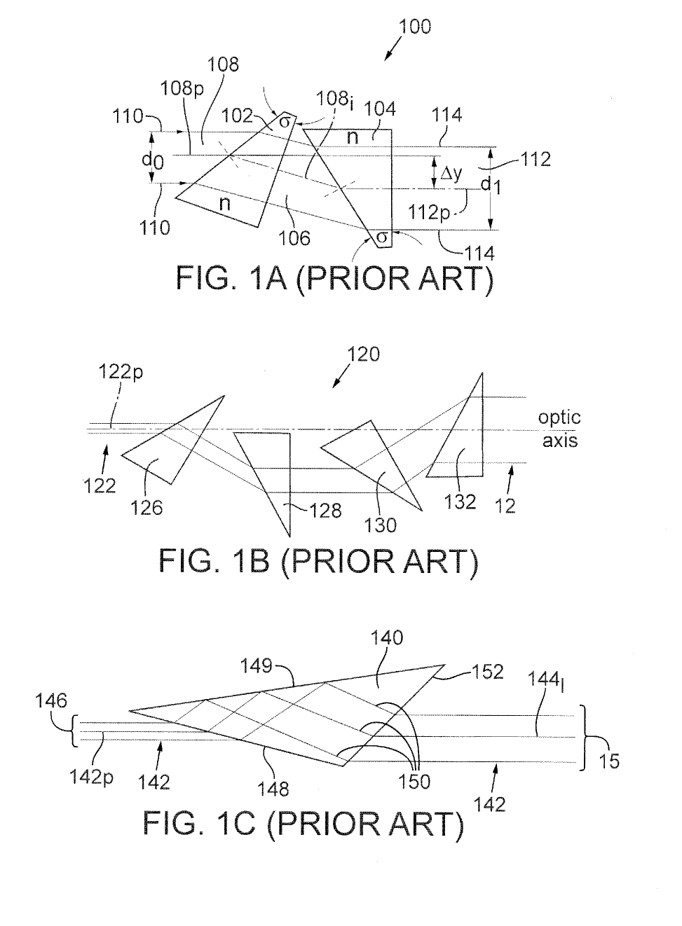

FIGS. 1A, 1B, and 1C are diagrams showing telescopic properties of three exemplary prior art prism configurations. In each example, the output beam is wider in one plane than the input beam. Hence, these are magnifying prisms, and each system is classified as a telescope. Prisms can correct asymmetry, but not astigmatism. Likewise, they can introduce asymmetry to a symmetric beam, but they cannot introduce astigmatism. Because each of the resulting light beams in FIGS. 1A-1C is collimated, they are all non-astigmatic. However, the change in image shape makes the resulting images asymmetric, or “anamorphic.”

With reference to FIG. 1A, a two-prism system 100 includes prisms 102 and 104 that are separated by an air gap 106. Prisms 102 and 104 have substantially the same index of refraction and are of substantially the same shape. An input beam 108 of size do defined by parallel light rays 110 enters prism 102, and after propagation through prism 102, air gap 106, and prism 104, exits prism 104 as an output beam 112 of size d₁ defined by parallel light rays 114. Prisms 102 and 104 are positioned and oriented relative to each other so that prism 102 angularly displaces principal light ray 108p of input beam 108 from its original direction of propagation to form an intermediate principal light ray 108i in air gap 106. Prism 104 angularly displaces intermediate principal light ray 108i from its direction of propagation to form principal light ray 112p of output light beam 112 propagating in a direction parallel to, but laterally offset by a distance Δy from, the original direction of propagation of principal light ray 108p.

With reference to FIG. 1B, a four-prism system 120 eliminates the lateral offset of the principal axes of an input beam 122 and an output beam 124. System 120 constitutes two two-prism systems 100 arranged in optical series and includes prisms 126, 128, 130, and 132, adjacent ones of which are mutually spaced apart by air gaps. Prisms 126, 128, 130, and 132 have substantially the same index of refraction and are of substantially the same shape. Prisms 126, 128, 130, and 132 are positioned and oriented relative to one another to produce from input beam 122 an output beam 124 having its principal light ray 124p that is coaxial with principal light ray 122p of input beam 122.

With reference to FIG. 1C, a single prism 140 also does not produce a lateral offset of the principal light rays of an input beam 142 and an output beam 144. Light rays 146 of input beam 142 enter prism 140 at its input surface 148 and undergo internal reflection at a glass/air interface 149 to form parallel light rays 150 that propagate through prism 140 and exit its output surface 152 as output beam 144 of parallel light rays 154. Principal light ray 144p of output beam 144 is coaxial with principal light ray 142p of input beam 142. The advantage of this single prism configuration is that it produces a magnified output beam 144 using only one optical element, ie., prism 140. The FIG. 1C example also illustrates, however, the inherent inefficiency of prismatic systems in that each time a light beam encounters a glass/air interface, a portion of the incident light beam energy is transmitted and the remaining energy is reflected. The amount of energy in the transmitted or reflected component of light propagation that is not recaptured in the system is therefore lost.

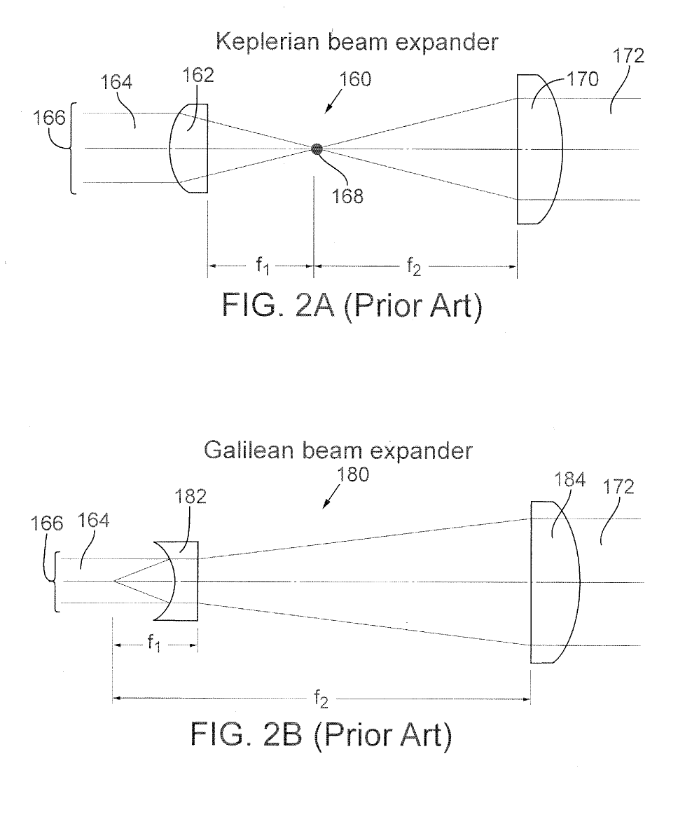

FIGS. 2A and 2B show examples of, respectively, Keplerian and Galilean telescopes built with lenses rather than prisms. Lenses bend the propagation directions of incident light according to the indices of refraction, curvatures of glass surfaces, and distances between successive elements of the lenses. While manufacturing curved lenses is more difficult than manufacturing flat prisms, an advantage of lenses over prisms is that they are optically axial, i.e., the output beam is coaxial with the input beam. This means that no lateral offset occurs.

A Keplerian telescope 160 shown in FIG. 2A includes a convex-plano lens 162 that receives an input light beam 164 formed of parallel light rays 166 and converges them to a principal focus 168 at a focal length f₁. The image focused at f₁ becomes a source image for a second, larger piano-convex cylindrical lens 170 with focal length f₂. Lens 170 collimates the light rays incident to it and produces an output light beam 172. Input light beam 164 and output light beam 172 are coaxial. A Galilean telescope 180 shown in FIG. 2B includes a concave-plano lens 182 that diverges light rays 166 of input light beam 164, which a plano-convex lens 184 collimates to produce output light beam 172. The greater width of output light beam 172 as compared with the width of input light beam 164 indicates that telescopes 160 and 180 magnify images carried by input light beam 164. Lenses 170 and 184 ensure production of collimated output light beams 172.

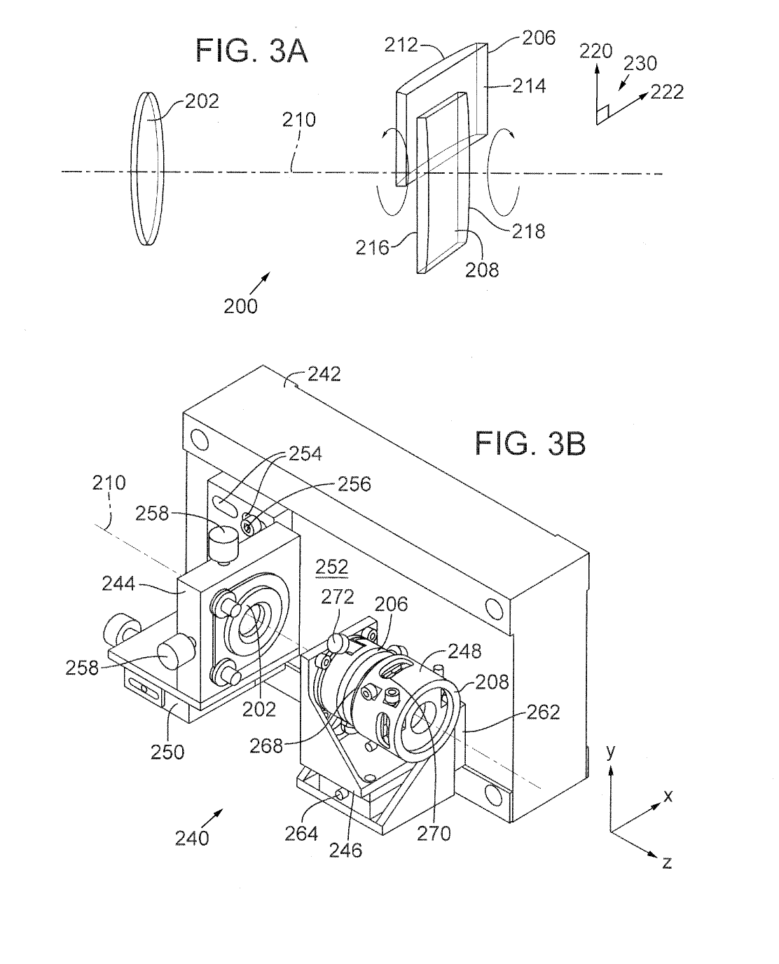

FIG. 3A shows a preferred embodiment of a vario-astigmatic beam expander 200, which is based on Galilean telescope 180 of FIG. 2B. Beam expander 200 comprises a spherical lens 202 for isotropic beam expansion greater than one and first and second cylindrical lenses 206 and 208 of the same magnifying power for symmetric beam expansion greater than one. (Cylindrical lenses 206 and 208 take the place of spherical lens 184 in Galilean telescope 180.) Spherical lens 202 and cylindrical lenses 206 and 208 are arranged in optical series along a system optic axis 210.

First cylindrical lens 206 has a convex surface 212 and a piano surface 214, and second cylindrical lens 208 has a piano surface 216 and a convex surface 218. In a preferred embodiment, cylindrical lenses 206 and 208 are positioned in proximity to each other with their respective piano surfaces 214 and 216 set in confronting relationship. Cylindrical lenses 206 and 208 are mounted for rotation about system optic axis 210 so that their respective principal axes 220 and 222 can be angularly displaced relative to each other or rotated together at a fixed angular displacement. Rotation of cylindrical lenses 206 and 208 can be accomplished by manual adjustment (FIG. 3B) or motive force applied by powered mechanism (not shown).

FIG. 3A shows cylindrical lenses 206 and 208 with their respective optic axes displaced by 90 degrees. An isotropically expanding input beam propagating from spherical lens 202 is of a size that is encompassed by the region of overlap of piano surfaces 214 and 216. Cylindrical lens 206 collimates the input beam in a first plane, and cylindrical lens 208 collimates the input beam in a second, orthogonal plane.

When they are rotated about system optic axis 210 such that their principal axes 220 and 222 are set at a displacement angle 230 of 90 degrees, cylindrical lenses 206 and 208 cooperate to function as a symmetric lens that imparts to the output beam no amount of astigmatism relative to that of the input beam. When they are rotated about system optic axis 210 such that their principal axes 220 and 222 assume various displacement angles 230 that differ from 90 degrees, cylindrical lenses 206 and 208 cooperate to impart to the output beam different amounts of astigmatism corresponding to the measure of displacement angle 230. When they are rotated together about system optic axis 210 such that their principal axes 220 and 222 remain at a fixed displacement angle 230, cylindrical lenses 206 and 208 cooperate to impart to the output beam a fixed amount of astigmatism at a variable axis of astigmatism corresponding to the extent of the rotation. Each cylindrical lens in vario-astigmatic beam expander 200 can be replaced with a multi-lens system performing the same function as a single lens.

FIG. 3B shows an optical module 240 embodying beam expander 200 of FIG. 3A, complete with mounting and adjustment hardware. Optical module 240 includes a mounting plate 242 to which are releasably coupled a lens mount 244 for spherical lens 202 and a lens mount 246 for a tubular cell 248 in which cylindrical lenses 206 and 208 are housed. In a preferred embodiment, spherical lens 202 has a focal length of −6.21 mm, and cylindrical lenses 206 and 208 each have focal lengths of 200 mm.

Lens mount 244 is attached to a translational stage 250 that is slidably mounted for movement along a surface 252 of mounting plate 242 in the direction of optic axis 210 (z-axis). Slots 254 in translational stage 250 allow for axial position adjustment of spherical lens 202 relative to cylindrical lenses 206 and 208. The lengths of slots 254 restrict the axial position of spherical lens 202, which a user fixes in place by tightening set screws 256 (one shown). Thumbscrews 258 provide user controllable x-axis and y-axis position adjustment of spherical lens 202.

Lens mount 246 is slidably attached to a translational stage 262 that is fixed to mounting plate 242. An adjustment knob 264 provides x-axis position adjustment of translational stage 262 and thereby cell 248 that houses cylindrical lenses 206 and 208. Cell 248 has mounted to its surface rotational adjustment mechanisms 268, 270, and 272 for varying the orientation of cylindrical lenses 206 and 208 about optic axis 210. Rotational adjustment mechanism 268 rotates cylindrical lens 206 about optic axis 210; rotational adjustment mechanism 270 rotates cylindrical lens 208 about optic axis 210; and rotational adjustment mechanism 272 rotates lenses 206 and 208 together about optic axis 210, thus preserving displacement angle 230 between their principal axes 220 and 222 while rotating the axis of net cylindrical power. When lenses 206 and 208 are set with their respective principal axes 220 and 222 orthogonal to each other, the resultant focal length is approximately equivalent to a 200 mm spherical lens. The axial spacing between lenses 206 and 208 in a preferred embodiment is 0.5-1 mm.

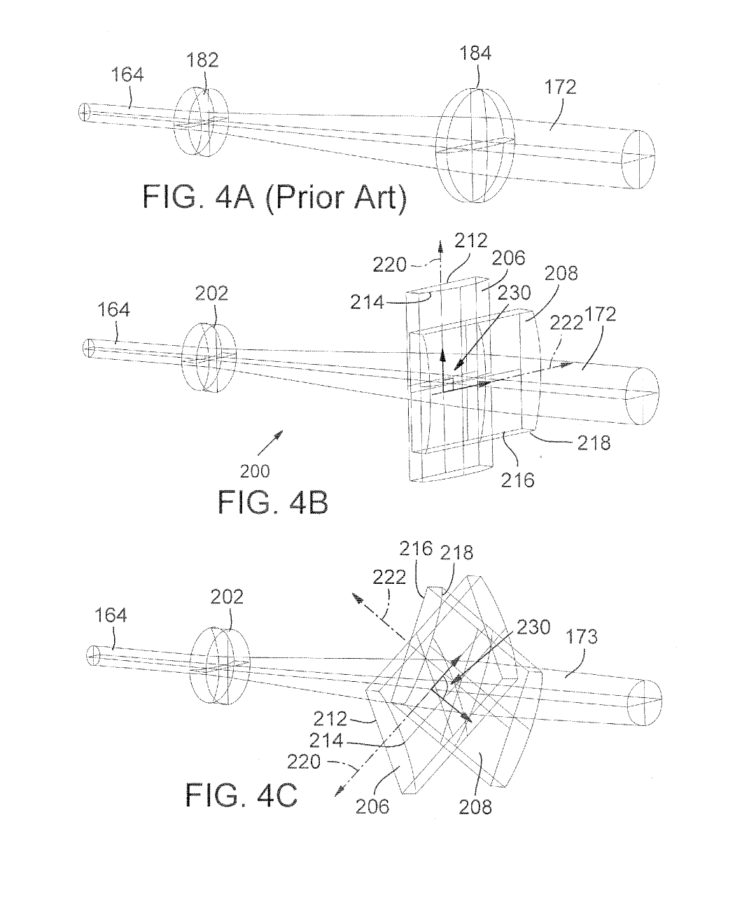

FIGS. 4A, 4B, and 4C are ray diagrams corresponding to, respectively, the lens system of Galilean telescope 180 shown in FIG. 2A and two configurations of the vario-astigmatic beam expander 200 shown in FIG. 3A. Comparison of FIGS. 4A and 4B demonstrates the equivalence of the output beams of vario-astigmatic beam expander 200 and Galilean telescope 180 when vario-astigmatic beam expander 200 is in its zero-astigmatism configuration, i.e., when principal axes 220 and 222, corresponding to the respective cylindrical lenses 206 and 208 are orthogonally aligned. In both cases, parallel rays 166 of input light beam 164 are expanded, in similar fashion, into an intermediate divergent beam and then re-collimated into (non-astigmatic) output beam 172. Whereas, as shown in FIG. 4C, vario-astigmatic beam expander 200 in its astigmatic configuration, with non-orthogonally aligned principal axes 220 and 222, ultimately produces output beam 173 with non-parallel, asymmetrically converging rays.

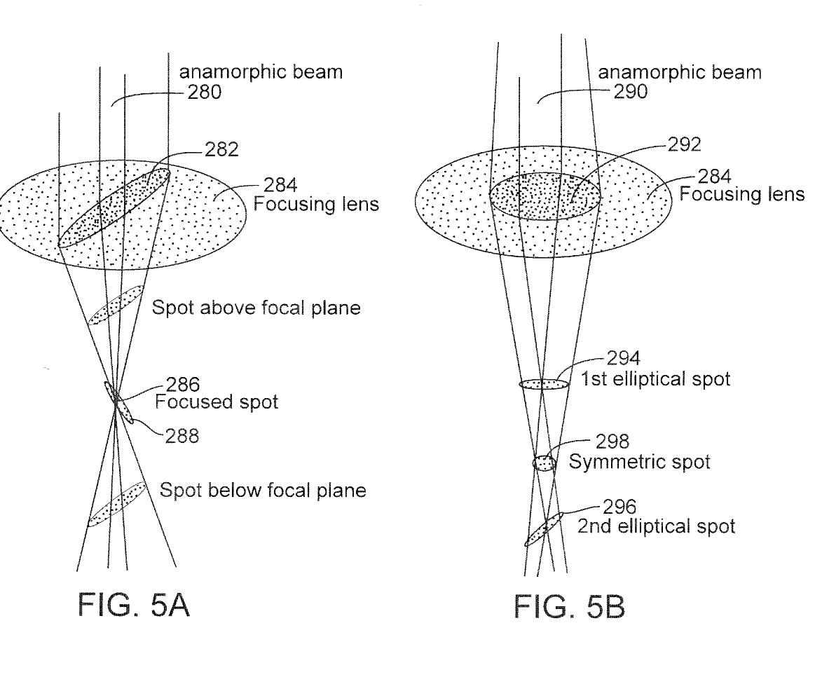

FIGS. 5A and 5B illustrate spot shape differences between an astigmatic beam and a collimated anamorphic beam, respectively. With reference to FIG. 5A, a collimated light beam 280, although composed of parallel light rays, forms an anamorphic image with an elliptical cross section 282 at the entrance surface of a focusing lens 284. Collimated beam 280 propagates through focusing lens 284, which converges the light rays of beam 280 to a point 286 lying in a single focal plane 288. With reference to FIG. 5B, an astigmatic light beam 290 forms an image with a circular cross section 292 at the entrance surface of focusing lens 284. Astigmatic beam 290 propagates through focusing lens 284, which converges the light rays of beam 290 to form elliptical spots 294 and 296 in separate focal planes located on either side of a plane in which there is an unfocused circular spot 298. Thus, the light rays of astigmatic beam 290 do not converge to a point at circular spot 298, whereas some of the light rays of astigmatic beam 290 converge at elliptical spots 294 and 296.

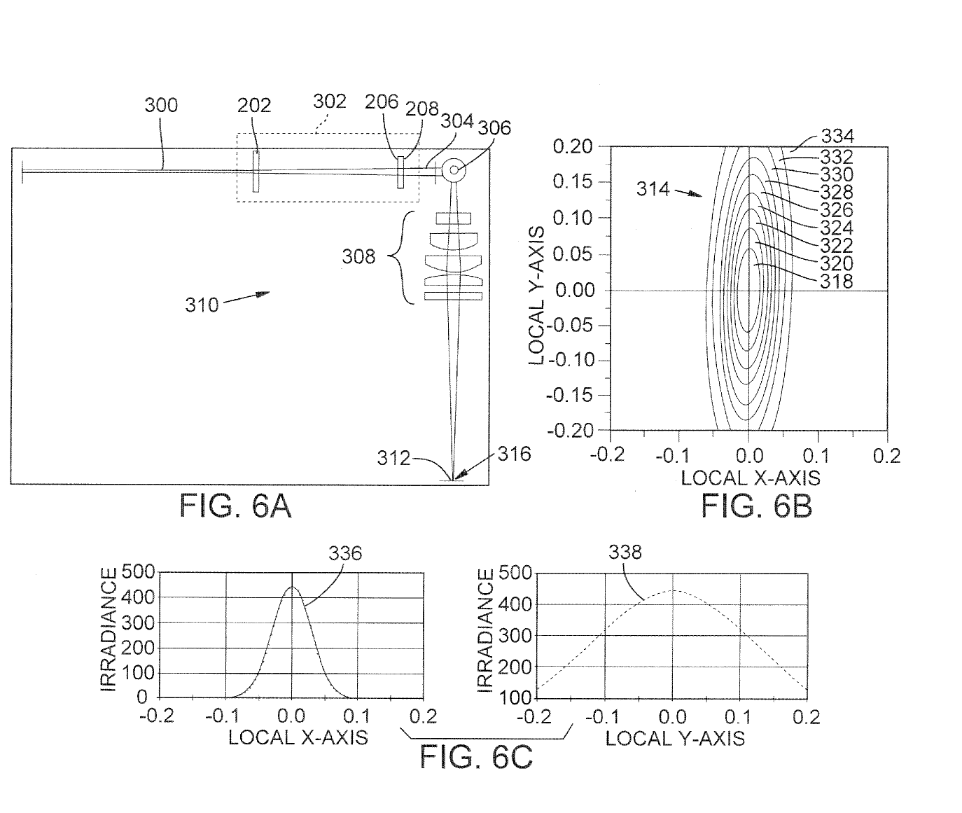

FIGS. 6B and 6C present energy distribution data at one focal point of an image created by a computer model of vario-astigmatic beam expander 200. The computer-generated data in FIGS. 6B and 6C correspond to the incidence of astigmatic light beam 290, as diagrammed in FIG. 5B. With reference to the lens diagram shown in FIG. 6A, an initially collimated beam 300 is made astigmatic by a beam expander 302. The configuration of lenses inside the dashed box, similar to the configuration in FIG. 3A, includes a single spherical lens 202 that spreads a collimated beam 300 isotropically, and cylindrical lenses 206 and 208 that have been rotated to produce a slightly astigmatic output beam 304. Two scan mirrors 306 deflect slightly astigmatic beam 304 downward through a series of optical elements 308 comprising a focusing scan lens 310 that focuses beam 304 onto a focal plane 312, which resides, for example, on a surface of a workpiece undergoing laser processing.

The graph in FIG. 6B is an iso-irradiance contour plot 314 of an elliptical focused laser spot 316 formed on the work surface at focal plane 312. Elliptical focused laser spot 316 corresponds either to elliptical spot 274 or to elliptical spot 276 in FIG. 5B, depending on which focal length distance is chosen as the position of focal plane 312. The major axis of elliptical image 316 is rotated clockwise a few degrees relative to the vertical axis because cylindrical lenses 206 and 208 were slightly rotated as a unit. Each elliptical contour 318-334 represents a 10% decrease in irradiance, starting from the center out, as detailed in Table 1 below:

TABLE 1

| Contour | Low Intensity | High Intensity |
|---|---|---|
| Reference Number | value | value |
| 318 | 2015 | 2266 |
| 320 | 1763 | 2015 |
| 322 | 1511 | 1763 |
| 324 | 1259 | 1511 |
| 326 | 1007 | 1259 |
| 328 | 755 | 1007 |
| 330 | 504 | 755 |
| 332 | 252 | 504 |
| 334 | 0 | 252 |

Corresponding light intensities along the x- and y-axes are shown FIG. 6C, each of which represents the intensity along a cut line through the contour plot 314 of elliptical image 316. A narrower peak 336 along the x-axis results because beam 304 is well-collimated in the x-direction, whereas a wider peak 338 along the y-axis results from the expanded image in the y-direction. If the other focal length were chosen, the orientation of the focused spot would rotate 90 degrees, causing wider peak 338 to extend along the x-axis and narrower peak 336 to extend along the y-axis.

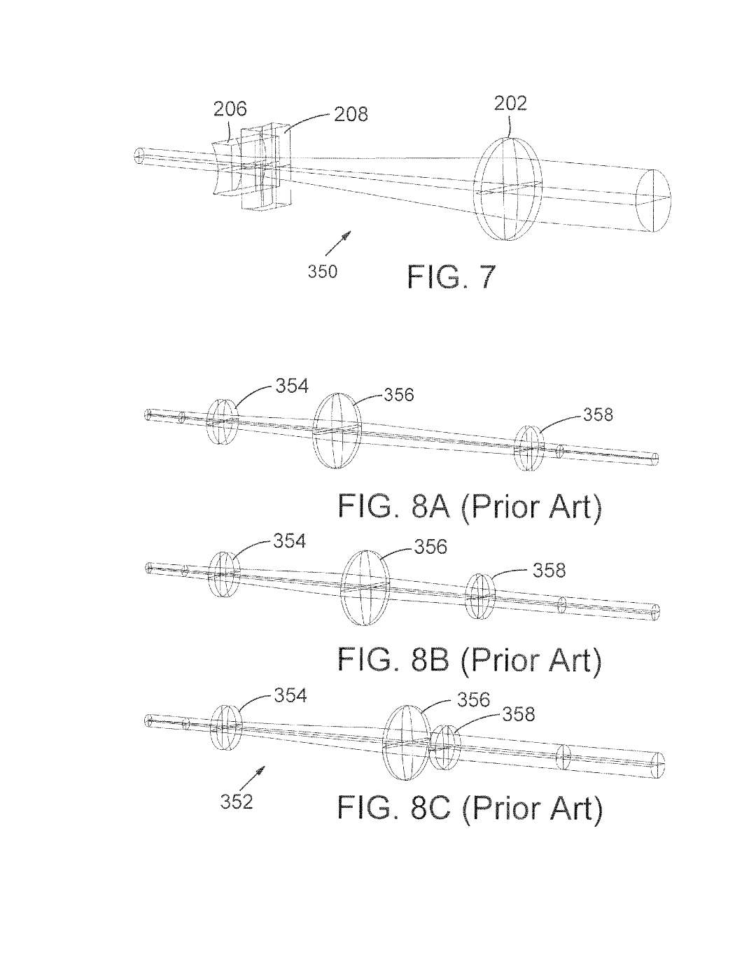

An alternative embodiment 350 of vario-astigmatic beam expander 200 is shown in FIG. 7, with crossed cylindrical lenses 206 and 208 placed in the light path of the input beam before, instead of after, spherical lens 202. This system is better suited to accepting an astigmatic beam, correcting the astigmatism, and then expanding the corrected beam into a collimated beam.

Another application of the cylindrical lens pair 206 and 208 featured in vario-astigmatic beam expander 200 is a zoom beam expander. With reference to FIGS. 8A, 8B, and 8C, a conventional zoom beam expander 352 can be constructed with a series of three lenses, 354, 356, and 358, in which magnification is determined by varying the distances between successive pairs of the lenses. Various configurations of such an embodiment, yielding expansion ratios of between 1 and 2.5 times the initial image size can be constructed according to Table 2 below:

TABLE 2

| Configuration/ | Distance from lens | Distance from lens 366 |
|---|---|---|
| expansion ratio | 364 to lens 366, mm | to lens 368, mm |
| 1/1:1 | 46 | 78.5 |
| 2/1:1.5 | 57 | 45 |
| 3/1:2.5 | 74.5 | 12.8 |

In general, the expansion ratio of system 352 increases with increasing distance between the first two lenses, and decreasing distance between the last two lenses. Lens elements comprising 354, 356, and 358 in this embodiment can be obtained from CVI of Albuquerque, N.Mex. (Part Nos. PLCC-15.0-25.8-UV, BICX-25.4-61.0-UV, and PLCC-15.0-51.5-UV, for lenses 1, 2, and 3, respectively).

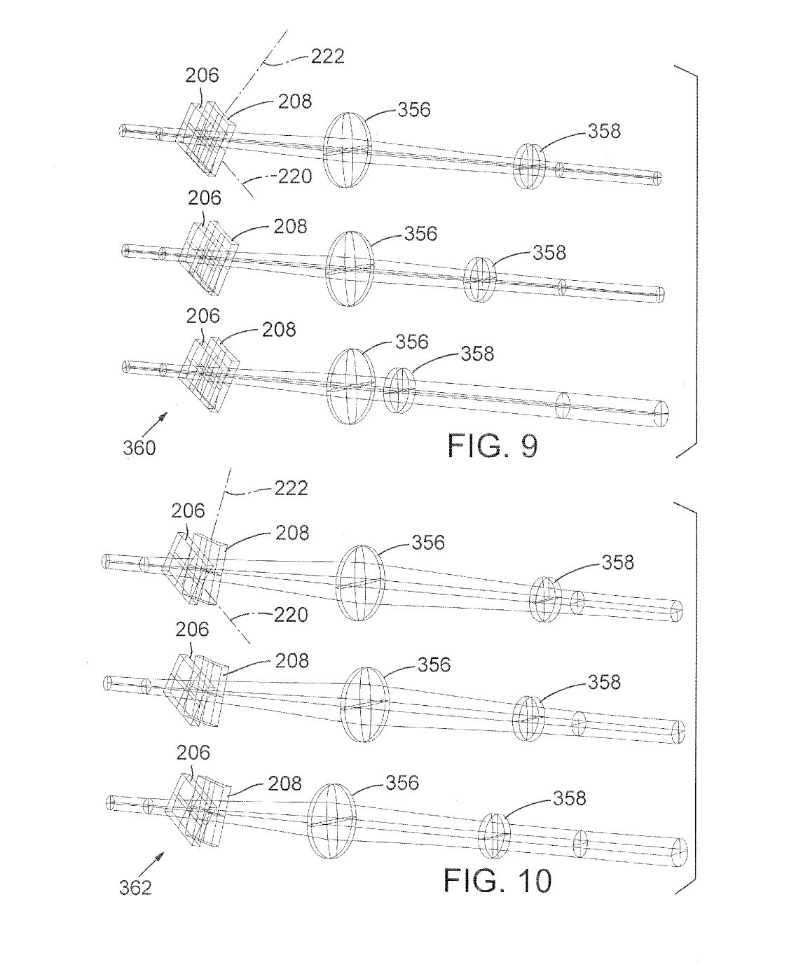

FIG. 9 shows a system 360, the light output of which is equivalent to that of system 352, in which a first lens element 354, a plano-concave zoom beam expander spherical lens, has been replaced by a pair of piano-concave cylindrical lenses 206 and 208 of similar and equal power, (both CVI Part No. RCCB40.0-25.4-UV), such as those used in beam expander 200 of FIG. 3A. Values in Table 2 characterizing system 352 are equivalent for system 360, in which principal axes 220 and 222 of cylindrical lenses 206 and 208 are orthogonally aligned in this case.

A similar zoom beam expander 362 is presented in FIG. 10, in which cylindrical lenses 206 and 208 have been rotated with respect to each other. System 362 is, therefore, capable of collimating an astigmatic input beam, or introducing variable astigmatism to a collimated input beam, as well as providing for variable expansion by adjusting distances to second lens 356 and third lens 358. An alternative embodiment to the configuration in FIG. 10 can be made by replacing lens 358, instead of lens 354, with the cylindrical pair of lenses 206 and 208.

It will be obvious to those having skill in the art that many changes may be made to the details of the above-described embodiments without departing from the underlying principles of the invention. The scope of the present invention should, therefore, be determined only by the following claims.

1. A method of producing from an input light beam a magnified output beam with an adjustable amount of astigmatism, comprising:
directing an input beam of light rays for incidence on a lens system to produce an output beam, the lens system having an optic axis and comprising first and second lens components positioned in optical series and having respective first and second principal axes angularly related to each other about the optic axis;
the first and second lens components cooperating to direct the incident light rays in, respectively, a first plane defined by the first principal axis and a second plane defined by the second principal axis; and
changing the angular relationship between the first and second principal axes of the respective first and second lens components to adjust an amount of astigmatism in the output beam.

2. The method of claim 1, in which the output beam has an axis of astigmatism, and further comprising rotating about the optic axis the first and second lens components while maintaining a fixed angular relationship between the first and second principal axes to change the axis of astigmatism of the output beam.

3. The method of claim 1, in which the first and second lens components include cylindrical lenses of the same magnifying power.

4. The method of claim 1, further comprising directing the input beam through one or more spherical lenses.

5. The method of claim 1, further comprising directing the output beam through one or more spherical lenses to magnify the output beam.

6. The method of claim 1, in which the input beam is symmetrically divergent.

7. The method of claim 1, in which the input beam is collimated, and the changing of the angular relationship results in an output beam with a nonzero amount of astigmatism.

8. The method of claim 1, in which the input beam is astigmatic, and the changing of the angular relationship results in a collimated output beam with a substantially zero amount of astigmatism.

9. The method of claim 1, further comprising directing the output beam for incidence on a workpiece.

10. The method of claim 9, in which the input beam of light rays propagates from a laser.
